(19) United States
(12) Patent Application Publication
(10) Pub. No.: US 2019/0343157 A1
(43) Pub. Date: Nov. 14, 2019

(54) FREEZING AND MULTI-STAGE FREEZING METHOD USING GAS AS REFRIGERANT

(71) Applicant: Xiang HUANG, Fujian (CN)

(72) Inventors: Xiang HUANG, Fujian (CN); Yushi HUANG, Fujian (CN)

(21) Appl. No.: 16/302,665

(22) PCT Filed: Apr. 25, 2017
(86) PCT No.: PCT/CN2017/081788

§ 371 Date: Mar. 1, 2019

(30) Foreign Application Priority Data
May 19, 2016 (CN) 201610332881.6

(51) Int. Cl. A23L 3/375; F25D 3/10

(52) U.S. Cl. CPC A23L 3/375; F25D 3/10

(57) ABSTRACT

A freezing method using a gas as a refrigerant, comprising: step 1: using a colorless, tasteless, and non-toxic liquid gas or supercritical gas as a refrigerant for freezing; step 2: immersing a product to be frozen in the liquid gas or the supercritical gas until the center temperature of the product to be frozen reaches the temperature of a freezing stage; and step 4: taking out the product to be frozen and transferring it to a frozen storage low temperature environment for storing. A multi-stage freezing method using a gas as a refrigerant, comprising: step 1: dividing the freezing process for a product to be frozen into at least two freezing stages; step 2: sequentially performing freezing operations corresponding to each of the freezing stages on the product to be frozen; and step 3: transferring, after balancing the pressure of the product to be frozen with the atmospheric pressure, the product to be frozen to the frozen storage low temperature environment for storing.

### BACKGROUND OF THE INVENTION

The present invention relates to the technical field of freeze storage, and more particularly relates to freezing and multi-stage freezing method using gas as refrigerant.

Immersion freezing employs a chiller to chill freezing fluid, and food will then be immersed into the freezing fluid to get frozen. The freezing fluid is also called refrigerant. Immersion freezing is a very effective kind of freezing method that possesses many advantages that other freezing methods do not possess. Immersion freezing has at least a few distinctive advantages as described below:

1. Quick freezing. Thermal conductivity of air in room temperature is 0.024 W/(M.K). Most kinds of liquid have a thermal conductivity of 0.116-0.628 W/(M.K), which is 5-26 times the thermal conductivity of air. Freezing by means of forced convection of air uses air in normal pressure as a freezing agent. By contrast, the freezing agent of immersion freezing is freezing liquid (refrigerant). Therefore, when compared with the former, the latter has a very quick freezing speed requiring a very short time to complete freezing.

2. Low power consumption. The freezing agent used in immersion freezing has a high value of thermal conductivity that enables effective thermal conduction. By contrast, freezing by means of forced convection of air uses air of normal pressure as freezing agent, wherein air has a low value of thermal conductivity that can only achieve slow thermal conduction; a certain flowing speed of the air has to be maintained to achieve freezing. Therefore, immersion freezing has very low power consumption. It is reported that the power consumed by immersion freezing is 25-30% lower than freezing by means of forced convection of air, while the yield rate is increased by more than 50%.

3. Better quality of frozen product. Due to rapid freezing speed, only small ice crystals are formed inside the frozen product, and they are evenly distributed inside the cells and in between the cells. The frozen product by and large remains juicy as before during defrosting, thereby better preserving the original textures, tastes and appearances of the original product.

Conventional immersion freezing usually uses binary refrigerants and ternary refrigerants. Binary refrigerants are mainly water soluble solutions, such as sodium chloride solution, calcium chloride solution and aqueous alcohol solution etc. Ternary refrigerants are mainly a mixed solution of sodium chloride, ethanol and water or a mixed solution of salt, sugar and water. However, since these refrigerants currently used in immersion freezing are liquids in normal temperature and normal pressure, at least the following several problems exist:

Direct immersion of food products to achieve immersion freezing is substantially a process that transfers heat and substances. On one hand, during immersion of the food products, some refrigerants will inevitably be transferred to the food products, and these liquid form of refrigerants are difficult to volatilize and are therefore left permanently in the food products (some alcoholic type of refrigerants are volatile yet they may somehow react with the frozen products and change the flavor of the products); as such, these refrigerants may change the flavor of the frozen food products and may even cause the amount of additives exceeding a prescribed limit. Even if the food products are first packed and then indirectly immersed in the refrigerants, it is possible that in actual practice, the packaging may be damaged and thus allowing the refrigerants to contact the food products; besides, this method increases the freezing cost.

On the other hand, during immersion freezing, some food product substances will inevitably be transferred to the refrigerants, and these substances will be dissolved in the refrigerants and thus very difficult to be separated from the refrigerants. Therefore, each time after immersion freezing, quality of the refrigerants decreases, and this leads to a low rate of recycling the refrigerants, which in turns greatly increases the freezing cost.

Some irregular or sharp food products (such as shrimps, crabs etc.) may easily damage the packaging that separates the food products from the refrigerants. Therefore, these food products are not suitable for indirect immersion freezing. Some small food products (such as cherries, lychees, longans and peas etc.) are difficult to be packaged individually or may otherwise greatly increase the cost; however, a plural number of small food products packaged in a single packaging may easily result in uneven freezing effect. Therefore, indirect immersion freezing of these small food products does not achieve good freezing effect.

Moreover, these refrigerants contain salts and alcohols, though in different concentrations. However, high concentration of salts may easily lead to corrosion of equipment. Ethanol is volatile, which can reduce the effectiveness of the refrigerants, and ethanol is also a hazardous substance that is flammable and explosive, thus it poses a potential risk against safety production.

### BRIEF SUMMARY OF THE INVENTION

An object of the present invention to provide a freezing method using gas as the refrigerant, wherein such method will not cause the refrigerant to remain in the food products, will not change the flavor of the food products, and can maintain the original quality of the refrigerant after immersion freezing.

To achieve the above object, the present invention has the following technical solution: A freezing method using gas as refrigerant, comprising the following steps:

Step 1: cooling the refrigerant down to a predetermined immersion temperature, wherein the refrigerant is a colorless, odorless and non-toxic liquefied gas or supercritical gas, and said immersion temperature is lower than a frozen stage temperature of a food product to be frozen; said immersion temperature can be determined according to specific properties of the food product to be frozen, such that a difference between a temperature of the food product to be frozen and the immersion temperature is lower than a temperature that may cause the food product to crack;

Step 2: immersing the food product into the liquefied gas or supercritical gas, until a central temperature of the food product reaches the frozen stage temperature; when performing step 2, performing temperature-controlled refrigeration cycles to the liquefied gas or supercritical gas so that the liquefied gas or supercritical gas is always maintained at the predetermined immersion temperature, and also imposing pressure consistently to the liquefied gas or supercritical gas so that the liquefied gas or supercritical gas is always maintained in a liquefied or supercritical condition;

Step 3: after the central temperature of the food product reaches the frozen stage temperature, separating the food product from the liquefied gas or supercritical gas, causing a pressure of the food product to be balanced with atmospheric pressure, and finally taking out and transferring the food product into a low temperature environment for freeze storage.

Preferred technical solutions are also provided for better implementation of the present invention:

Further including a step 4: before transferring the food product into the low temperature environment for freeze storage in step 3, applying ice coating on the food product or packaging the food product by vacuum packaging after being taken out.

Further, gas of the colorless, odorless and non-toxic liquefied gas or supercritical gas is air, carbon dioxide or nitrogen.

Other colorless, odorless and non-toxic gases should be obvious to a person skilled in the art, and these other gases can also be used as the refrigerant according to the method of the present invention without any additional inventive efforts. Therefore, use of these other colorless, odorless and non-toxic gases as the refrigerant should also fall within the scope of protection of the present invention.

In here, the frozen stage temperature refers to the central temperature of the food product.

Another object of the present invention is to provide a multi-stage freezing method using gas as refrigerant, comprising the following steps:

Step 1: dividing a freezing process of a food product to be frozen into at least two freezing stages; determining a frozen stage temperature of each of the freezing stages; preparing a kind of colorless, odorless and non-toxic liquefied gas or supercritical gas for each freezing stage as the refrigerant of the respective freezing stage; and cooling each refrigerant of each freezing stage into a stage immersion temperature predetermined for the respective freezing stage, wherein the stage immersion temperature is lower than the frozen stage temperature of the respective freezing stage and higher than the frozen stage temperature of a next freezing stage; the stage immersion temperature can be determined according to specific properties of the food product to be frozen, such that a difference between a temperature of the food product to be frozen and the stage immersion temperature is lower than a temperature that may cause the food product to crack;

Step 2: based on a temperature sequence of the frozen stage temperatures of the freezing stages, performing freezing procedures of the food product in the freezing stages in sequential order, wherein after the freezing procedures in one freezing stage is finished, the food product is transferred to the next freezing stage for a next stage of freezing procedures in the refrigerant used in the next freezing stage, until all freezing procedures of all freezing stages are finished;

the freezing procedures are as follows: immersing the food product into the refrigerant of a current freezing stage, until a central temperature of the food product reaches the frozen stage temperature of the current freezing stage; after that separating the food product from the refrigerant of the current freezing stage; when performing the freezing procedures, performing temperature-controlled refrigeration cycles to the refrigerant of the current freezing stage so that the refrigerant of the current freezing stage is always maintained at the predetermined stage immersion temperature of the current freezing stage, and also imposing pressure consistently to the refrigerant of the current freezing stage so that the refrigerant of the current freezing stage is always maintained in a liquefied or supercritical condition;

Step 3: when all the freezing procedures of all the freezing stages are finished, causing a pressure of the food product to be balanced with atmospheric pressure, and finally taking out and transferring the food product into a low temperature environment for freeze storage.

Preferred technical solutions are also provided for better implementation of the present invention:

Further, gas of the colorless, odorless and non-toxic liquefied gas or supercritical gas is air, carbon dioxide or nitrogen.

Other colorless, odorless and non-toxic gases should be obvious to a person skilled in the art, and these other gases can also be used as the refrigerant according to the method of the present invention without any additional inventive efforts. Therefore, use of these other colorless, odorless and non-toxic gases as the refrigerant should also fall within the scope of protection of the present invention.

In the two methods as described above, liquefied gas or supercritical gas is used as the refrigerant, and during the entire process of both methods described above, freezing is performed under maintained pressure. These two features as integrated in the two methods of the present invention described above constitute the major differences and the novelty aspects of the present invention compared with the prior arts. Accordingly, the two methods form a unity of invention. Compared with the prior arts, the two methods as described above share the following advantages:

1. The present invention uses liquefied gas or supercritical gas as the refrigerant. Therefore, during freezing procedures, the use of temperature-controlled refrigeration apparatus can accurately control the liquefied gas or supercritical gas so as to control the freezing temperature of the food product.

2. The refrigerant of the present invention is gaseous in normal temperature and normal pressure. Therefore, the refrigerant that remains in the food product frozen according to the methods of the present invention will naturally vaporize and completely volatilize after defrosting, and so will not left in the food product; since the refrigerant is colorless, odorless and non-toxic, the refrigerant will not change the flavor of the frozen food product, and will not have any food safety problem.

3. The refrigerant of the present invention vaporizes naturally after pressure release, and thus it is very easy to be separated from impurities. Therefore, the quality of the refrigerant remains unchanged.

4. The refrigerant does not have salts and therefore will not corrode equipment.

Compared with prior arts, the multi-stage freezing method using gas as refrigerant provided by the present invention also has the following advantage:

1. By using liquefied gas or supercritical gas of different temperatures to perform multi-stage freezing, the temperature difference between the food product and the refrigerant is greatly reduced, thereby facilitating the appropriate selections of immersion temperatures, so that the food product will not crack during rapid and super cold immersion freezing.

### DETAILED DESCRIPTION OF THE INVENTION

The present invention will be further described in detail below with reference to some embodiments.

### Embodiment 1

Liquefied carbon dioxide is used as the refrigerant for immersion freezing. The immersion temperature of the refrigerant is set to be −50° C. The frozen stage temperature of the food product to be frozen is −18° C. The current embodiment comprises the following steps:

Step 1: cooling the liquefied carbon dioxide down to −50° C.;

Step 2: filling a freeze tank with the cooled liquefied carbon dioxide; immersing the food product into the liquefied carbon dioxide, until a central temperature of the food product reaches −18° C.; when performing step 2, performing temperature-controlled refrigeration cycles to the liquefied carbon dioxide so that the liquefied carbon dioxide is always maintained at −50° C. (in actual practice, due to various constraints such as the refrigeration apparatus being used, the temperature actually maintained may differ, and a difference within a range of ±5° C. will be normally considered an acceptable range of difference), and also imposing a working pressure of 3.0 MPa consistently to the liquefied carbon dioxide so that the liquefied carbon dioxide is always maintained in a liquefied condition;

Step 3: after the central temperature of the food product reaches −18° C., separating the food product from the liquefied carbon dioxide, causing a pressure inside the freeze tank to be balanced with atmospheric pressure, and then opening the freeze tank, and finally taking out and transferring the food product into a low temperature environment for freeze storage.

Further, before transferring the food product into the low temperature environment for freeze storage in step 3, applying ice coating on the food product taken out from the freeze tank after taken out.

### Embodiment 2

Supercritical air is used as the refrigerant for immersion freezing. The immersion temperature of the refrigerant is set to be −65° C. The frozen stage temperature of the food product to be frozen is −60° C. The current embodiment comprises the following steps:

Step 1: cooling the supercritical air down to −65° C.;

Step 2: filling a freeze tank with the cooled supercritical air; immersing the food product into the supercritical air, until a central temperature of the food product reaches −60° C.; when performing step 2, performing temperature-controlled refrigeration cycles to the supercritical air so that the supercritical air is always maintained at −65° C. (in actual practice, due to various constraints such as the refrigeration apparatus being used, the temperature actually maintained may differ, and a difference within a range of ±5° C. will be normally considered an acceptable range of difference), and also imposing a working pressure of 5.2 MPa consistently to the supercritical air so that the supercritical air is always maintained in a supercritical condition;

Step 3: after the central temperature of the food product reaches −60° C., separating the food product from the supercritical air, causing a pressure inside the freeze tank to be balanced with atmospheric pressure, and then opening the freeze tank, and finally taking out and transferring the food product into a low temperature environment for freeze storage.

### Embodiment 3

Liquefied carbon dioxide is used as the refrigerant for immersion freezing. The immersion temperature of the refrigerant is set to be −50° C. The frozen stage temperature of the food product to be frozen is −18° C. The current embodiment comprises the following steps:

Step 1: cooling the liquefied carbon dioxide down to −45° C.;

Step 2: filling a freeze tank with the cooled liquefied carbon dioxide; immersing the food product into the liquefied carbon dioxide, until a central temperature of the food product reaches −18° C.; when performing step 2, performing temperature-controlled refrigeration cycles to the liquefied carbon dioxide so that the liquefied carbon dioxide is always maintained at −45° C. (in actual practice, due to various constraints such as the refrigeration apparatus being used, the temperature actually maintained may differ, and a difference within a range of ±5° C. will be normally considered an acceptable range of difference), and also imposing a working pressure of 3.0 MPa consistently to the liquefied carbon dioxide so that the liquefied carbon dioxide is always maintained in a liquefied condition;

Step 3: after the central temperature of the food product reaches −18° C., separating the food product from the liquefied carbon dioxide, causing a pressure inside the freeze tank to be balanced with atmospheric pressure, and then opening the freeze tank, and finally taking out and transferring the food product into a low temperature environment for freeze storage.

Further, before transferring the food product into the low temperature environment for freeze storage in step 3, applying ice coating on the food product taken out from the freeze tank.

### Embodiment 4

Supercritical air is used as the refrigerant for immersion freezing. The immersion temperature of the refrigerant is set to be −55° C. The frozen stage temperature of the food product to be frozen is −50° C. The current embodiment comprises the following steps:

Step 1: cooling the supercritical air down to −55° C.;

Step 2: filling a freeze tank with the cooled supercritical air; immersing the food product into the supercritical air, until a central temperature of the food product reaches −50° C.; when performing step 2, performing temperature-controlled refrigeration cycles to the supercritical air so that the supercritical air is always maintained at −55° C. (in actual practice, due to various constraints such as the refrigeration apparatus being used, the temperature actually maintained may differ, and a difference within a range of ±5° C. will be normally considered an acceptable range of difference), and also imposing a working pressure of 5.2 MPa consistently to the supercritical air so that the supercritical air is always maintained in a supercritical condition;

Step 3: after the central temperature of the food product reaches −50° C., separating the food product from the supercritical air, causing a pressure inside the freeze tank to be balanced with atmospheric pressure, and then opening the freeze tank, and finally taking out and transferring the food product into a low temperature environment for freeze storage.

### Embodiment 5

Supercritical nitrogen is used as the refrigerant for immersion freezing. The immersion temperature of the refrigerant is set to be −60° C. The frozen stage temperature of the food product to be frozen is −55° C. The current embodiment comprises the following steps:

Step 1: cooling the supercritical nitrogen down to −60° C.;

Step 2: filling a freeze tank with the cooled supercritical nitrogen; immersing the food product into the supercritical nitrogen, until a central temperature of the food product reaches −55° C.; when performing step 2, performing temperature-controlled refrigeration cycles to the supercritical nitrogen so that the supercritical nitrogen is always maintained at −60° C. (in actual practice, due to various constraints such as the refrigeration apparatus being used, the temperature actually maintained may differ, and a difference within a range of ±5° C. will be normally considered an acceptable range of difference), and also imposing a working pressure of 3.5 MPa consistently to the supercritical nitrogen so that the supercritical nitrogen is always maintained in a supercritical condition;

Step 3: after the central temperature of the food product reaches −60° C., separating the food product from the supercritical nitrogen, causing a pressure inside the freeze tank to be balanced with atmospheric pressure, and then opening the freeze tank, and finally taking out and transferring the food product into a low temperature environment for freeze storage.

### Embodiment 6

Supercritical air is used as the refrigerant. The freezing process is divided into two freezing stages. The stage immersion temperatures of the two freezing stages are −55° C. and −105° C. respectively, and the corresponding frozen stage temperatures of the two freezing stages are in sequence −50° C. and −100° C. respectively. The current embodiment comprises the following steps:

Step 1: dividing the freezing process of a food product to be frozen into two freezing stages; wherein the frozen stage temperature of the first freezing stage is −50° C., and the frozen stage temperature of the second freezing stage is −100° C.;

Step 2: preparing a portion of supercritical air for each freezing stage as the refrigerant of the respective freezing stage; cooling the refrigerant of the first freezing stage to −55° C., and cooling the refrigerant of the second freezing stage to −105° C.;

Step 3: filling a freeze tank with the cooled refrigerant of the first freezing stage; immersing the food product into the refrigerant of the first freezing stage, until a central temperature of the food product reaches −50° C.; during the first freezing stage, performing temperature-controlled refrigeration cycles to the refrigerant of the first freezing stage so that the refrigerant of the first freezing stage is always maintained at −55° C. (in actual practice, due to various constraints such as the refrigeration apparatus being used, the temperature actually maintained may differ, and a difference within a range of ±5° C. will be normally considered an acceptable range of difference), and also imposing a working pressure of 5.2 MPa consistently to the refrigerant of the first freezing stage so that the refrigerant of the first freezing stage is always maintained in a supercritical condition;

Step 4: when the central temperature of the food product reaches −50° C., separating the food product from the refrigerant of the first freezing stage, and then filling the freeze tank with the cooled refrigerant of the second freezing stage, immersing the food product into the refrigerant of the second freezing stage, until the central temperature of the food product reaches −100° C.; during the second freezing stage, performing temperature-controlled refrigeration cycles to the refrigerant of the second freezing stage so that the refrigerant of the second freezing stage is always maintained at −105° C. (in actual practice, due to various constraints such as the refrigeration apparatus being used, the temperature actually maintained may differ, and a difference within a range of ±5° C. will be normally considered an acceptable range of difference), and also imposing a working pressure of 5.2 MPa consistently to the refrigerant of the second freezing stage so that the refrigerant of the second freezing stage is always maintained in a supercritical condition;

Step 5: after the central temperature of the food product reaches −100° C., separating the food product from the refrigerant of the second freezing stage, causing a pressure inside the freeze tank to be balanced with atmospheric pressure, and then opening the freeze tank, and finally taking out and transferring the food product into a low temperature environment for freeze storage.

### Embodiment 7

Supercritical nitrogen and liquefied nitrogen are used as refrigerants. The freezing process is divided into four freezing stages. The stage immersion temperatures of the four freezing stages are −50° C., −100° C., −145° C., and −193° C. respectively, and the corresponding frozen stage temperatures of the four freezing stages are in sequence −45° C., −95° C., −140° C., and −190° C. respectively. The current embodiment comprises the following steps:

Step 1: dividing the freezing process of a food product to be frozen into four freezing stages; wherein the frozen stage temperature of the first freezing stage is −45° C., the frozen stage temperature of the second freezing stage is −95° C., the frozen stage temperature of the third freezing stage is −140° C., and the frozen stage temperature of the fourth freezing stage is −190° C.;

Step 2: preparing a portion of supercritical nitrogen for each of the first three freezing stages as the refrigerants of the respective freezing stages, and preparing a portion of liquefied nitrogen for the fourth freezing stage as the refrigerant of the fourth freezing stage; cooling the refrigerant of the first freezing stage to −50° C., cooling the refrigerant of the second freezing stage to −100° C., cooling the refrigerant of the third freezing stage to −145° C., and cooling the refrigerant of the fourth freezing stage to −193° C.;

Step 3: filling a freeze tank with the cooled refrigerant of the first freezing stage; immersing the food product into the refrigerant of the first freezing stage, until a central temperature of the food product reaches −45° C.; during the first freezing stage, performing temperature-controlled refrigeration cycles to the refrigerant of the first freezing stage so that the refrigerant of the first freezing stage is always maintained at −45° C. (in actual practice, due to various constraints such as the refrigeration apparatus being used, the temperature actually maintained may differ, and a difference within a range of ±5° C. will be normally considered an acceptable range of difference), and also imposing a working pressure of 3.6 MPa consistently to the refrigerant of the first freezing stage so that the refrigerant of the first freezing stage is always maintained in a supercritical condition;

Step 4: when the central temperature of the food product reaches −45° C., separating the food product from the refrigerant of the first freezing stage, and then filling the freeze tank with the cooled refrigerant of the second freezing stage, immersing the food product into the refrigerant of the second freezing stage, until the central temperature of the food product reaches −95° C.; during the second freezing stage, performing temperature-controlled refrigeration cycles to the refrigerant of the second freezing stage so that the refrigerant of the second freezing stage is always maintained at −100° C. (in actual practice, due to various constraints such as the refrigeration apparatus being used, the temperature actually maintained may differ, and a difference within a range of ±5° C. will be normally considered an acceptable range of difference), and also imposing a working pressure of 3.6 MPa consistently to the refrigerant of the second freezing stage so that the refrigerant of the second freezing stage is always maintained in a supercritical condition;

Step 5: when the central temperature of the food product reaches −95° C., separating the food product from the refrigerant of the second freezing stage, and then filling the freeze tank with the cooled refrigerant of the third freezing stage, immersing the food product into the refrigerant of the third freezing stage, until the central temperature of the food product reaches −140° C.; during the third freezing stage, performing temperature-controlled refrigeration cycles to the refrigerant of the third freezing stage so that the refrigerant of the third freezing stage is always maintained at −145° C. (in actual practice, due to various constraints such as the refrigeration apparatus being used, the temperature actually maintained may differ, and a difference within a range of ±5° C. will be normally considered an acceptable range of difference), and also imposing a working pressure of 3.6 MPa consistently to the refrigerant of the third freezing stage so that the refrigerant of the third freezing stage is always maintained in a supercritical condition;

Step 6: when the central temperature of the food product reaches −140° C., separating the food product from the refrigerant of the third freezing stage, and then filling the freeze tank with the cooled refrigerant of the fourth freezing stage, immersing the food product into the refrigerant of the fourth freezing stage, until the central temperature of the food product reaches −190° C.; during the fourth freezing stage, performing temperature-controlled refrigeration cycles to the refrigerant of the fourth freezing stage so that the refrigerant of the fourth freezing stage is always maintained at −193° C. (in actual practice, due to various constraints such as the refrigeration apparatus being used, the temperature actually maintained may differ, and a difference within a range of ±5° C. will be normally considered an acceptable range of difference), and also imposing a working pressure of 3.6 MPa consistently to the refrigerant of the fourth freezing stage so that the refrigerant of the fourth freezing stage is always maintained in a liquefied condition;

Step 7: after the central temperature of the food product reaches −190° C., separating the food product from the refrigerant of the fourth freezing stage, causing a pressure inside the freeze tank to be balanced with atmospheric pressure, and then opening the freeze tank, and finally taking out and transferring the food product into a low temperature environment for freeze storage.

The present invention is illustrated and described by using the above embodiments and their alternative configurations. However, it should be understood that various changes and modifications are possible provided that they are not deviated from the scope of the spirit of the present invention. Therefore, it should be understood that, the present invention is only limited by the claims and their equivalents, and should not be otherwise limited no matter in what sense.

What is claimed is:

1. A freezing method using gas as refrigerant, comprising the following steps:
Step 1: cooling the refrigerant down to a predetermined immersion temperature, wherein the refrigerant is a colorless, odorless and non-toxic liquefied gas or supercritical gas, and said immersion temperature is lower than a frozen stage temperature of a food product to be frozen;
Step 2: immersing the food product into the liquefied gas or supercritical gas, until a central temperature of the food product reaches the frozen stage temperature; when performing step 2, performing temperature-controlled refrigeration cycles to the liquefied gas or supercritical gas so that the liquefied gas or supercritical gas is always maintained at the predetermined immersion temperature, and also imposing pressure consistently to the liquefied gas or supercritical gas so that the liquefied gas or supercritical gas is always maintained in a liquefied or supercritical condition;
Step 3: after the central temperature of the food product reaches the frozen stage temperature, separating the food product from the liquefied gas or supercritical gas, causing a pressure of the food product to be balanced with atmospheric pressure, and finally taking out and transferring the food product into a low temperature environment for freeze storage.

2. The method of claim 1, wherein before transferring the food product into the low temperature environment for freeze storage in step 3, applying ice coating on the food product after the food product is taken out.

3. A multi-stage freezing method using gas as refrigerant, comprising the following steps:
Step 1: dividing a freezing process of a food product to be frozen into at least two freezing stages; determining a frozen stage temperature of each of the freezing stages; preparing a kind of colorless, odorless and non-toxic liquefied gas or supercritical gas for each freezing stage as the refrigerant of the respective freezing stage; and cooling each refrigerant of each freezing stage into a stage immersion temperature predetermined for the respective freezing stage, wherein the stage immersion temperature of each freezing stage is lower than the frozen stage temperature of the same respective freezing stage and higher than the frozen stage temperature of a next freezing stage;
Step 2: based on a temperature sequence of the frozen stage temperatures of the freezing stages, performing freezing procedures of the food product in the freezing stages in sequential order, wherein after the freezing procedures in one freezing stage is finished, the food product is transferred to the next freezing stage for a next stage of freezing procedures in the refrigerant used in the next freezing stage, until all freezing procedures of all freezing stages are finished;
the freezing procedures are as follows: immersing the food product into the refrigerant of a current freezing stage, until a central temperature of the food product reaches the frozen stage temperature of the current freezing stage; after that separating the food product from the refrigerant of the current freezing stage; when performing the freezing procedures, performing temperature-controlled refrigeration cycles to the refrigerant of the current freezing stage so that the refrigerant of the current freezing stage is always maintained at the predetermined stage immersion temperature of the current freezing stage, and also imposing pressure consistently to the refrigerant of the current freezing stage so that the refrigerant of the current freezing stage is always maintained in a liquefied or supercritical condition;
Step 3: when all the freezing procedures of all the freezing stages are finished, causing a pressure of the food product to be balanced with atmospheric pressure, and finally transferring the food product into a low temperature environment for freeze storage.
